(19) United States
(12) Patent Application Publication
(10) Pub. No.: US 2009/0158213 A1
(43) Pub. Date: Jun. 18, 2009

(54) MOBILE TERMINAL AND METHOD OF CONFIGURING AND EXECUTING APPLICATION FUNCTIONS FOR THE SAME

(75) Inventor: Ji Youn RYU, Yongin-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/328,087

(22) Filed: Dec. 4, 2008

(30) Foreign Application Priority Data
Dec. 18, 2007 (KR) 10-2007-0133261

(51) Int. Cl. G06F 3/048

(52) U.S. Cl. 715/825; 715/810

(57) ABSTRACT

A mobile terminal and method of configuring and executing application functions for the same are provided. The mobile terminal includes a display unit for displaying a list of all functions related to a selected application, and for displaying, in response to a request for a related function display during application execution, a related function list, a memory unit for storing a general purpose table containing mappings between shortcut keys and commonly used functions, and for storing a user specific table containing mappings between shortcut keys and related functions set by a user, and a control unit for configuring the related function list for the selected application, for executing the selected application, and, in response to a key input during application execution, for directly invoking a related function or for controlling the display unit to display the related function list and then for invoking a related function selected from the related function list.

### PRIORITY

This application claims the benefit under 35 U.S.C. §119(a) of a Korean patent application filed in the Korean Intellectual Property Office on Dec. 18, 2007 and assigned Serial No. 10-2007-0133261, the entire disclosure of which is hereby incorporated by reference.

### BACKGROUND OF THE INVENTION

1. Field of the Invention

The present invention relates to a mobile terminal. More particularly, the present invention relates to a mobile terminal and method of configuring and executing functions related to an application program in the mobile terminal.

2. Description of the Related Art

With advances in communication technologies and rapid popularization, the trend in mobile terminals is to have an increasing number of functions. For example, photographing has been a function specific to a camera. However, mobile terminals having a photographing function as a supplementary function have become more popular than cameras having only a photographing function. Functions from other fields such as a music playing function and an Internet surfing function also have been gradually incorporated into the mobile terminals for user convenience.

In contrast, the size of the mobile terminals has become gradually smaller for higher portability. That is, whereas a number of functions to be provided increases, the size of mobile terminals decreases. This has resulted in user inconvenience. A representative example is related to displaying a list of provided functions on a display unit of a mobile terminal. In other words, for a small mobile terminal with a small display unit, there is a limitation on a number of displayable functions on a single screen. When an application program has multiple related functions of which the quantity exceeds a preset number, only the preset number of related functions are displayed on a screen, and the remaining functions may be hidden and displayed on the next screen or displayed one at a time in response to user inputs. This situation is depicted in FIGS. 1A and 1B.

FIG. 1A illustrates a displayed list of related functions of a text message application according to a conventional art, and FIG. 1B illustrates a displayed list of related functions of a photographing application according to a conventional art.

FIG. 1A illustrates a list of related functions applicable to Short Message Service (SMS) messages received by the text message application. When the user inputs a particular key like a ‘menu’ key during execution of an SMS application, a list of related functions of the application is displayed. For example, related functions displayed in FIG. 1A include a ‘reply’ function to transmit a reply message to the sender of a received message being viewed, a ‘forward’ function to forward the received message being viewed to another person, and a ‘delete’ function to remove the received message being viewed. When the number of related functions exceeds seven (the number of items displayable in a single screen in FIG. 1A), those functions after the seventh function may not be displayed and may be hidden. That is, those functions, after the ‘save body’ function that saves the body part of the received message being viewed, may be hidden. To identify the hidden function, the user has to traverse related functions by inputting a preset key such as a direction key.

FIG. 1B illustrates a list of related functions applicable to photographs taken by a photographing application. Related functions displayed in FIG. 1B include an ‘attach multi-mail’ function to attach a photograph being viewed to multimedia mail, and a ‘set wallpaper’ function to set a photograph being viewed as a wallpaper for a particular function. When the number of related functions exceeds seven (the number of items displayable in a single screen in FIG. 1B), those functions after the seventh function may not be displayed and may be hidden. That is, those functions, after a ‘create slide’ function displaying multiple photographs in sequence, are hidden. As a result, when a list of related functions is displayed as in FIGS. 1A and 1B, to identify hidden functions, the user has to traverse related functions by inputting a preset key such as a direction key until a desired function is displayed. In addition, the user may use more frequently a hidden function than a displayed function. That is, for an application, a display format of related functions is fixed at the manufacturing time of the mobile terminal, and the user has to traverse displayed but less frequently used functions to find a hidden but frequently used function. Further, a new related function cannot be added later by the user to the list of related functions fixed at the time of manufacturing.

Hence, there is a need for method to provide a technique that permits the user to easily select a desired function even when the number of related functions in an application exceeds a preset number, or permits the user to extend the list of related functions in a desired manner.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for executing related functions of an application program in a mobile terminal.

Another aspect of the present invention is to provide a method and apparatus enabling fast execution of related functions of an application program.

Further another aspect of the present invention is to provide a method and apparatus that enable the user to configure a list of related functions of an activated application or to add a new related function to the list according to user preferences.

In accordance with an exemplary embodiment of the present invention, a method of configuring functions related to applications in a mobile terminal is provided. The method includes displaying, in a function configuration mode, a list of all functions related to a selected application, requesting a user to determine whether a function to be configured is present in the displayed list, selecting, when the function to be configured is present in the displayed list, the function, displaying, when the function to be configured is not present in the displayed list, a general purpose table containing mappings between commonly used functions and shortcut keys, and selecting one of the functions in the general purpose table, assigning a shortcut key to the selected function, and adding the selected function to a related function list for the selected application if the selected function is not present in the display list.

In accordance with another exemplary embodiment of the present invention, a method of executing functions related to applications in a mobile terminal is provided. The method includes activating a selected one of the applications, determining, during execution of the selected application, whether a request for a related function is made using a key input, determining, when the request for the related function is made, whether the request for the related function is a request for invocation or a request for display of a related function list, searching, when the request for the related function is the request for invocation, a stored table containing mappings between shortcut keys and related functions for the key input, and invoking the related function corresponding to the key input, and displaying, when the request for the related function is the request for display, the related function list, and invoking the related function selected by a user from the related function list.

In accordance with another exemplary embodiment of the present invention, a mobile terminal is provided. The terminal includes a display unit for displaying, in a function configuration mode, a list of all functions related to a selected application, and for displaying, in response to a request for related function display during application execution, a related function list of the selected application, a memory unit for storing a general purpose table containing mappings between shortcut keys and commonly used functions, and for storing a user specific table containing mappings between shortcut keys and related functions set by a user, a control unit for configuring the related function list for the selected application, for executing the selected application, and, in response to a key input during application execution, for directly invoking a related function or controlling the display unit to display the related function list, and then for invoking a related function selected from the related function list. The control unit includes a function configurator for determining, in a function configuration mode, whether a function to be configured is present in a displayed list of functions, for selecting, when a function to be configured is present, the function, for displaying, when the function to be configured is not present, the general purpose table and for selecting one of the functions from the general purpose table, for assigning a shortcut key to the selected function if necessary, and for adding the selected function to the related function list if the selected function is not present in the display list, and a function invoker for determining, during execution of the selected application, whether a request for a related function is made using a key input, for determining, when the request for the related function is made, whether the request for the related function is a request for invocation or a request for a related function display, for searching, when the request for the related function is the request for invocation, the user specific table for the key input and for invoking the related function corresponding to the key input, and for displaying, when the request for the related function is the request for the related function display, the related function list, and for invoking the related function selected from the related function list according to a user input.

Hereinabove, the features and advantages of aspects of the present invention are described in a relatively broad perspective to help those skilled in the art in understanding exemplary embodiments of the present invention. Other features and advantages constituting the subject matter of exemplary embodiments of the present invention will be more apparent from the following detailed description.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1A illustrates a displayed list of related functions of a text message application according to a conventional art;

FIG. 1B illustrates a displayed list of related functions of a photographing application according to a conventional art;

FIG. 2 is a block diagram illustrating a mobile terminal according to an exemplary embodiment of the present invention;

FIG. 3 is a flowchart illustrating a method of configuring related functions of an application program based on user preferences according to an exemplary embodiment of the present invention;

FIG. 4 is a flowchart illustrating a method of executing related functions of an application program according to an exemplary embodiment of the present invention;

FIG. 5A illustrates a displayed list of related functions according to an exemplary embodiment of the present invention; and

FIG. 5B illustrates a user specific table for invoking related functions in an application according to an exemplary embodiment of the present invention.

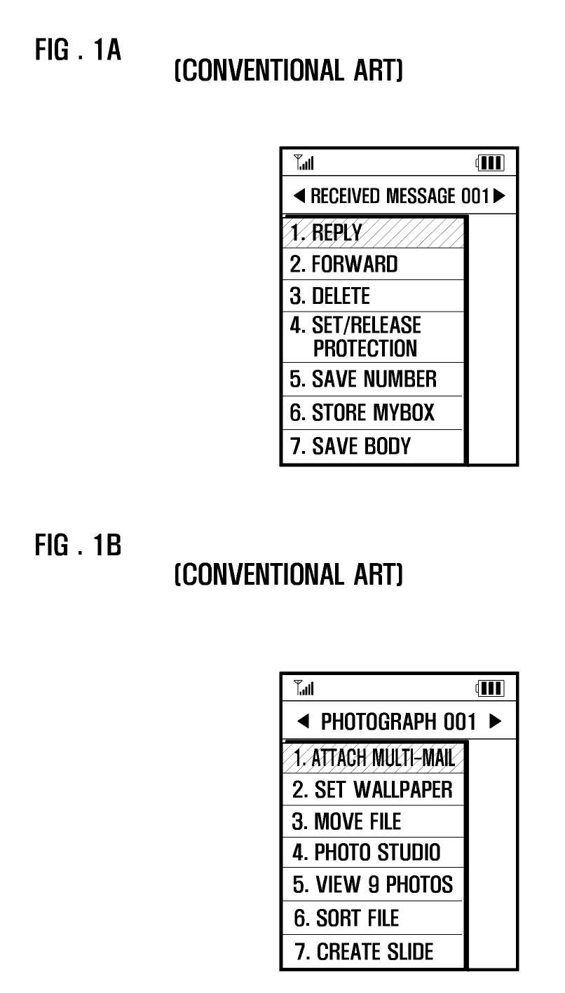

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but is to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

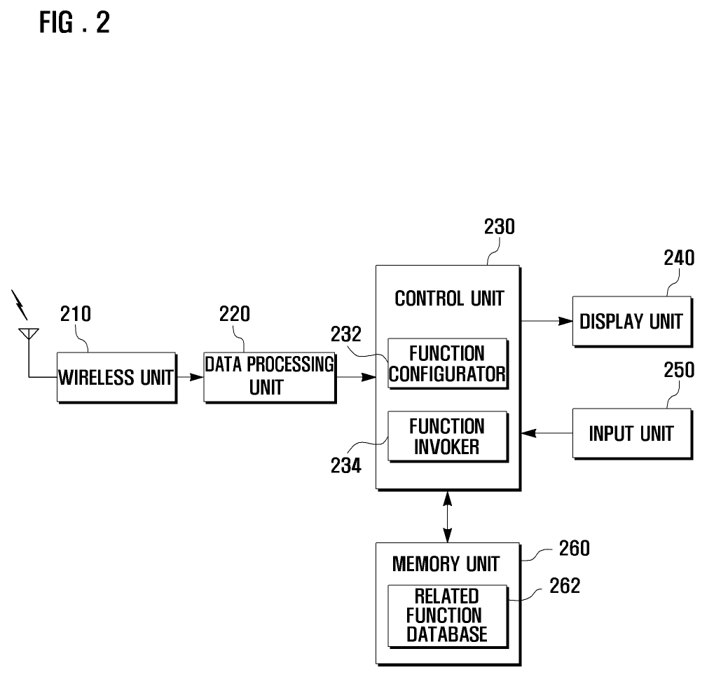

FIG. 2 is a block diagram illustrating a mobile terminal according to an exemplary embodiment of the present invention.

Referring to FIG. 2, a wireless unit 210 performs wireless communication for the mobile terminal. The wireless unit 210 may include a Radio Frequency (RF) transmitter (not shown) for upconverting the frequency of a signal to be transmitted and amplifying the signal, and an RF receiver (not shown) for low-noise amplifying a received signal and downconverting the frequency of the received signal. A data processing unit 220 may include a means for encoding and modulating a signal to be transmitted, and a means for demodulating and decoding a received signal. That is, the data processing unit 220 may include a modulator/demodulator (modem) and a coder/decoder (codec).

A control unit 230 controls overall operations of the mobile terminal. In particular, the control unit 230 may include a function configurator 232 to configure related functions of an application according to user preferences, and a function invoker 234 to invoke a requested function of configured related functions during application execution.

A display unit 240 displays data from the control unit 230. In particular, the display unit 240 displays a list of available related functions or a list of related functions configured by a user, during execution of an application. The display unit 240 may be provided as a panel of Liquid Crystal Display (LCD) devices. In this case, the display unit 240 may include a controller for controlling the LCD, and a video memory in which image data is stored and an LCD element. If the display unit 240 is provided as a touch pad or a touch screen, it may perform a part or all the functions of an input unit 250. The input unit 250 includes keys to input alphanumeric information, and function keys to set various functions.

A memory unit 260 may include a program memory section and a data memory section. The program memory section stores programs to operate the mobile terminal, and the data memory section stores data generated from execution of the programs. In particular, the memory unit 260 stores a related function database 262 that includes a general purpose table containing information about common shortcut keys and associated functions, and a user specific table containing information about shortcut keys and associated functions set by the user.

Hereinabove, the description is limited to those elements of the mobile terminal necessary for configuring and invoking related functions. However, if necessary, the mobile terminal may further include a camera module to take a picture, an image processing unit, an audio processing unit to handle multimedia mail containing voice data, and the like.

In general, devices or application programs having similar uses are designed to provide similar or substantially identical means for invoking frequently used related functions rather than infrequently used ones. For example, in word processors running on personal computers, a key combination ‘CTRL+C’ is used as a shortcut for copying a selected text portion, and a key combination ‘CTRL+Z’ is used as a shortcut for undoing the last performed operation. Hence, users of commonly used programs with similar uses are familiar with particular shortcut keys. A shortcut key is a key or a key combination assigned to a function, and a user can conveniently invoke the function using the assigned shortcut key. When, a function of an application program in a mobile terminal is to be invoked during execution, the function may be provided at the time of manufacturing of the mobile terminal or at the time of development of the application program. In an exemplary embodiment of the present invention, a means for configuring functions is provided so that the functions can be invoked through shortcut keys familiar to the user, where some of the functions may be not provided at the time of manufacturing. In an exemplary function configuration, related functions of an application program are configured on the basis of user preferences, so that a desired function is not hidden from the screen because the desired function is arranged after a preset number of other related functions in the screen.

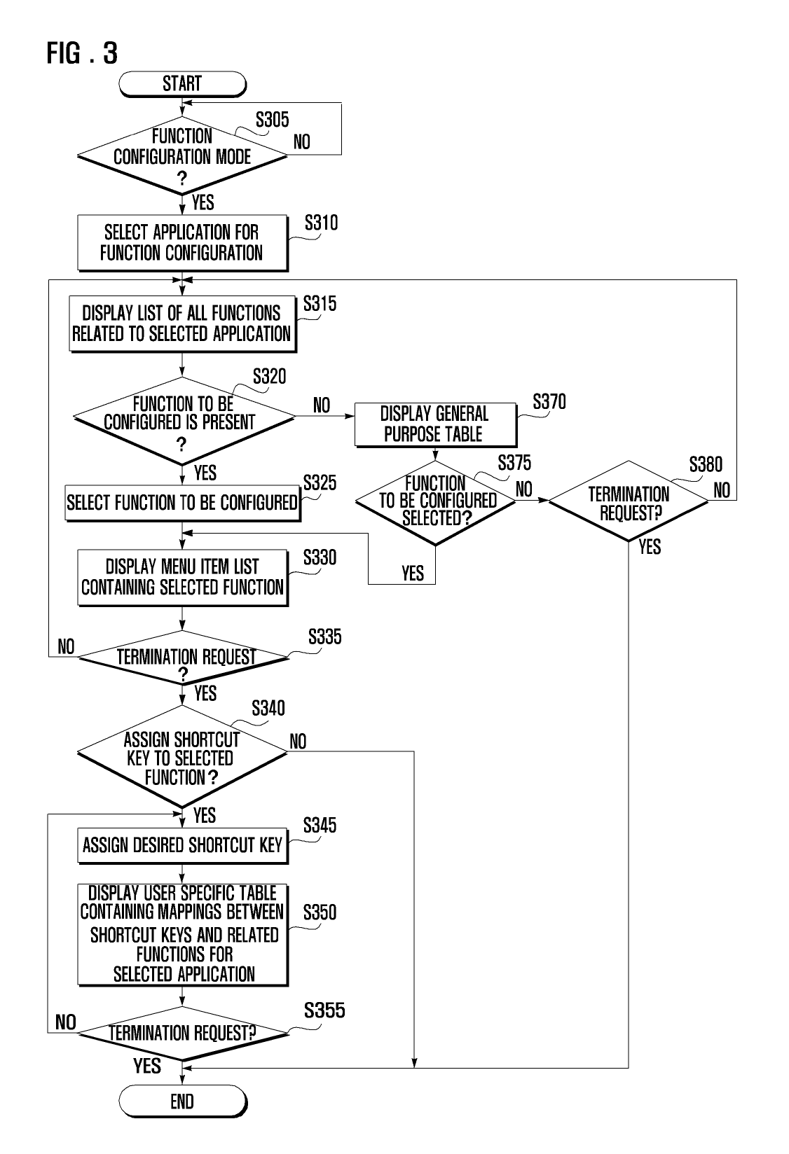

FIG. 3 is a flowchart illustrating a method of configuring related functions of an application program on the basis of user preferences according to an exemplary embodiment of the present invention.

Referring to FIGS. 2 and 3, the function configurator 232 of the control unit 230 determines whether the mobile terminal is in a function configuration mode in step S305. In the function configuration mode, functions of an application may be configured according to user preferences. When the mobile terminal is in the function configuration mode, the function configurator 232 requests the user to select an application program for related function configuration in step S310. The user can enter a selection input through the input unit 250. The function configurator 232 displays a list of all functions of the selected application program on the display unit 240 in step S315. Different application programs can have different functions. For example, a photographing program can have a function for setting a photographed image as a wallpaper for the mobile terminal, and a message editing program can have a function for forwarding a received message to another person. The function configurator 232 determines whether a function to be configured is present in the displayed list in step S320. The presence of a function to be configured can be determined on the basis of a user input. If a function to be configured is present in the displayed list, the function configurator 232 selects a function to be configured according to a user input in step S325. The function configurator 232 displays a related function list containing the selected function in step S330. Generally, in a mobile terminal, a list of functions provided by an application program is displayed in a corresponding menu, and menu items of the menu are displayed upon an input of the ‘menu’ key of the input unit 250. For the purpose of user convenience, in an exemplary embodiment of the present invention, a list of functions related to a selected application program is displayed in a menu, and the list of related functions is referred to as a menu item list. A key other than the ‘menu’ key may also be assigned to display a list of related functions. The function configurator 232 determines whether a termination request for a function selection is received in step S335. If the termination request for the function selection is received from the user, the function configurator 232 proceeds to step S340. If the termination request is not received, the function configurator 232 returns to step S315.

After function selection, the function configurator 232 requests the user to decide whether to assign a shortcut key to a selected function in step S340. If the user decides not to assign a shortcut key, the function configurator 232 finishes the procedure. If the user decides to assign a shortcut key, the function configurator 232 assigns a desired shortcut key to the selected function in step S345. For example, in a message editing program, a shortcut key ‘MENU+S’ can be assigned to a function ‘save’ for saving the current message. Later, a long key press on the ‘menu’ key followed by a key press on the ‘S’ key during execution of a message editing program invokes the ‘save’ function to save the message being edited. Information about shortcut key assignment is stored in a user specific table. That is, the user specific table, containing information about mappings between shortcut keys and related functions, is stored in the related function database 262. The function configurator 232 displays the user specific table containing mappings between shortcut keys and related functions specified for the selected application program in step S350. The function configurator 232 determines whether a termination request for a shortcut key assignment is received in step S355. If the termination request for the shortcut key assignment is received, the function configurator 232 finishes the procedure. If the termination request is not received, the function configurator 232 returns to step S345.

In contrast, if a function to be configured is not present in the displayed list at step S320, the function configurator 232 displays the general purpose table stored in the related function database 262 in step S370. The general purpose table contains mappings between key combinations familiar to the user and related functions common to frequently used applications. For example, a key press on the ‘CTRL’ key followed by a key press on the ‘D’ key during execution of a word processor invokes a function for deleting a selected text portion. In the general purpose table, the key combination ‘CTRL+D’ is mapped to the ‘delete’ function. An example of the general purpose table is shown in Table 1. In Table 1, the ‘MENU’ key replaces the ‘CTRL’ key, which may be not present in a mobile terminal. However, the ‘MENU’ key itself may also be replaced with another key according to user preferences.

TABLE 1

| Shortcut key | Related function |
|---|---|
| MENU + N | Create new item (ex. new document) |
| MENU + S | Save current item |
| MENU + Z | Undo last edit operation |
| MENU + P | Print |
| MENU + C | Copy selected section |
| MENU + V | Paste |
| MENU + F | Search |
| MENU + D | Delete selected item |

Table 1 illustrates shortcut keys assigned to frequently used functions related to conventional word processors. For example, invocation of the ‘create’ function triggers a creation of a new item such as a new document. When the ‘create’ function is present in the related function list, it may be invoked in two ways. First, the ‘create’ function can be selected for invocation after the related function list is displayed in response to a key press on the ‘menu’ key. Second, use of a shortcut key, a key press on the ‘menu’ key followed by a key press on the ‘N’ key results in rapid invocation of the ‘create’ function. Table 1 illustrates shortcut keys that may be familiar to users of word processing programs. An input of shortcut key results in direct invocation of a corresponding function. Referring to Table 1, a key press on the ‘menu’ key followed by a key press on the ‘S’ key results in invocation of the ‘save’ function. A key press on the ‘menu’ key followed by a key press on the ‘Z’ key results in invocation of the ‘undo’ function. A key press on the ‘menu’ key followed by a key press on the ‘P’ key results in invocation of the ‘print’ function. A key press on the ‘menu’ key followed by a key press on the ‘C’ key results in invocation of the ‘copy’ function. A key press on the ‘menu’ key followed by a key press on the ‘V’ key results in invocation of the ‘paste’ function. A key press on the ‘menu’ key followed by a key press on the ‘F’ key results in invocation of the ‘search’ function. A key press on the ‘menu’ key followed by a key press on the ‘D’ key results in invocation of the ‘delete’ function. Although Table 1 illustrates shortcut keys used in conventional word processing programs, the general purpose table may also include familiar shortcut keys frequently used in other application programs and entries thereof can be added or modified by the user. Referring back to FIG. 3, the function configurator 232 determines whether a function is selected from the general purpose table in step S375. After selection of a function from the general purpose table, a shortcut key can be assigned to the selected function. The function associated with an assigned shortcut key can be added to the related function list. If a function is selected, the function configurator 232 proceeds to step S330. If a function is not selected, the function configurator 232 determines whether a termination request for function configuration is received in step S380. If a termination request for function configuration is received from the user, the function configurator 232 finishes the procedure. If a termination request is not received, the function configurator 232 returns to step S315. As described above, after a function is selected and added to the menu item list, a shortcut key can be assigned to the selected function. Alternatively, a shortcut key can be assigned immediately after an application program is selected in the function configuration mode.

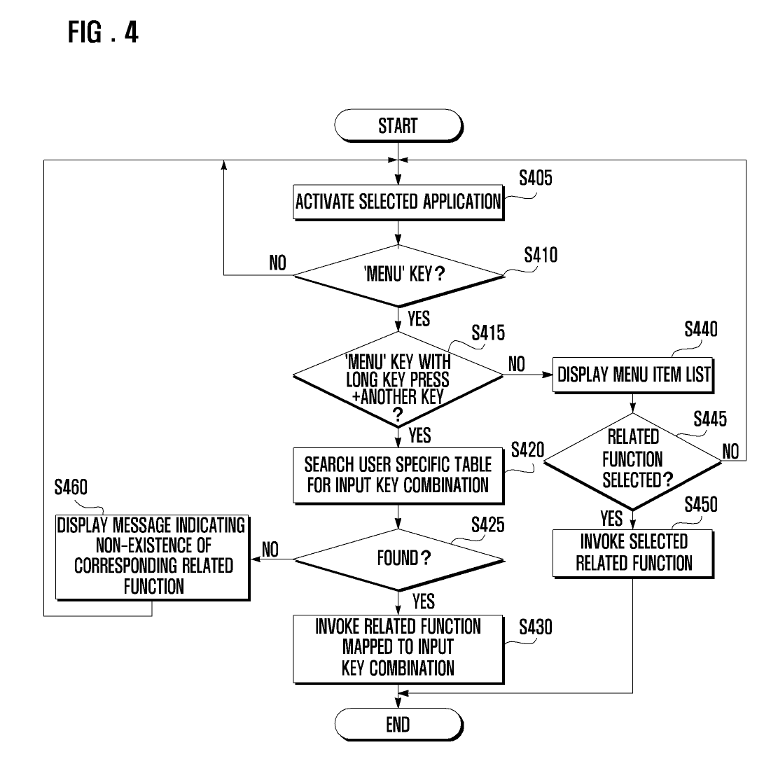

FIG. 4 is a flowchart illustrating a method of executing related functions of an application program according to an exemplary embodiment of the present invention.

Referring to FIG. 4, the control unit 230 of the mobile terminal activates an application program requested by the user in step S405. The control unit 230 determines whether the ‘menu’ key is input in step S410. If the ‘menu’ key is not input, the control unit 230 returns to step S405 for application activation. If the ‘menu’ key is input, the function invoker 234 of the control unit 230 determines whether the input ‘menu’ key is a long key press and is followed by another key in step S415. If the input ‘menu’ key is a long key press and is followed by another key, the function invoker 234 proceeds to step S420. If the input ‘menu’ key is not a long key press or is not followed by another key, the function invoker 234 proceeds to step S440. In an exemplary embodiment of the present invention, a long key press on the ‘menu’ key followed by a preset key is interpreted as an input of a shortcut key for invoking a related function, and a single ‘menu’ key is interpreted as a command to display a list of related functions. In other words, the function invoker 234 regards a key combination of a long key press on the ‘menu’ key and an alphabet key as an invocation of a related function, and regards a short key press on the ‘menu’ key as an input for displaying a list of related functions. Here, a key press can be regarded as a long key press if it exceeds a duration of a preset time, and regarded as short key press if it does not exceed the duration of the preset time. The function invoker 234 searches for the stored user specific table in step S420. Here, the user specific table contains mappings between key combinations and related functions for the activated application program. The function invoker 234 determines whether the key combination of the ‘menu’ key and alphabet key is present in the user specific table in step S425. If the key combination is present, the function invoker 234 invokes a related function associated with the key combination in step S430. If the key combination is not present, the function invoker 234 informs the user of non-existence of a related function associated with the key combination in step S460. In this case, a message indicating non-existence of a related function is displayed on the display unit 240. Alternatively, an alert sound may be produced.

In contrast, if the input ‘menu’ key is a long key press and is followed by another key in step S415, the function invoker 234 displays a list of related functions of the activated application program in step S440. The related functions can be functions selected by the user from all available related functions of the activated application program. The function invoker 234 determines whether a related function is selected from the displayed list in step S445. If no function is selected, the function invoker 234 returns to step S405. If a related function is selected, the function invoker 234 invokes the selected related function in step S450. Accordingly, the user can directly execute related functions of an application program using familiar shortcut keys. In addition, even when a large number of related functions are available from an application, the user does not have to traverse many displayed but unstructured related functions to select a desired related function.

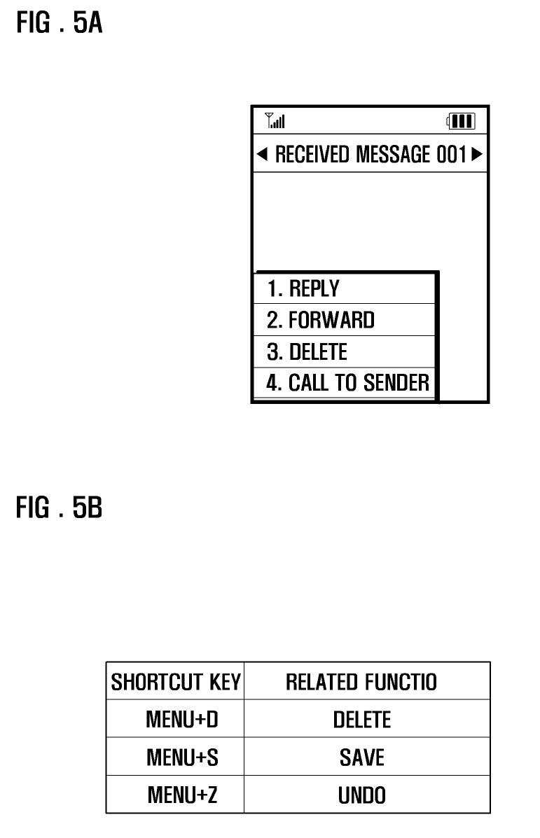

FIG. 5A is a displayed list of related functions according to an exemplary embodiment of the present invention. 100461 Referring to FIG. 5A, a list of related functions displayed is provided in response to an input of the ‘menu’ key with a short key press during execution of a text message viewer. The related function list displayed in FIG. 5A is configured according to user preferences, and includes a ‘reply’ function, a ‘forward’ function, a ‘delete’ function, a ‘call to sender’ function and the like. That is, during text message viewing, the user frequently invokes the ‘reply’ function, the ‘forward’ function, the ‘delete’ function, and the ‘call to sender’ function, and has configured the related function list so as to include only these functions. As a result, functions unused by or unnecessary for the user are not included in the related function list, and the related, function list including only frequently used functions is short but effective for display.

FIG. 5B, illustrates a user specific table for invoking related functions in an application for mappings between shortcut keys and related functions according to an exemplary embodiment of the present invention. Referring to FIG. 5B, during execution of the text message viewer, an input of the ‘menu’ key with a long key press and ‘D’ key invokes a ‘delete’ function for deleting the current message, an input of the ‘menu’ key with a long key press and ‘S’ key invokes a ‘save’ function for saving the current message, and an input of the ‘menu’ key with a long key press and ‘Z’ key invokes an ‘undo’ function for canceling the last edit operation.

As apparent from the above descriptions, a list of related functions of an application program is configured according to user preferences and displayed. Hence, a display list of the related functions may be simplified and the user may directly select a desired related function. In addition, the related functions can be invoked immediately and conveniently by utilizing familiar shortcut keys. Shortcut keys are assigned using alphabet keys. Hence, restrictions due to a shortage of keys are relaxed, and shortcut keys can be assigned to a variety of related functions.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method of configuring functions related to applications in a mobile terminal, the method comprising:
displaying, in a function configuration mode, a list of all functions related to a selected application;
requesting a user to determine whether a function to be configured is present in the displayed list;
selecting, when the function to be configured is present in the displayed list, the function;
displaying, when the function to be configured is not present in the displayed list, a general purpose table containing mappings between commonly used functions and shortcut keys, and selecting one of the functions in the general purpose table;
assigning a shortcut key to the selected function; and
adding the selected function to a related function list for the selected application if the selected function is not present in the displayed list.

2. The method of claim 1, wherein the assigning of the shortcut key to the selected function comprises storing the assigned shortcut key in a table as a mapping between the shortcut key and the function.

3. The method of claim 2, wherein the shortcut key comprises a combination of two keys.

4. The method of claim 3, wherein the combination of two keys comprises a combination of a ‘menu’ key and an alphabet key.

5. The method of claim 4, wherein a long key press on the ‘menu’ key followed by an alphabet key is recognized as a shortcut key.

6. A method of executing functions related to applications in a mobile terminal, the method comprising:
activating a selected one of the applications;
determining, during execution of the selected application, whether a request for a related function is made using a key input;
determining, when the request for the related function is made, whether the request for the related function is a request for invocation or a request for display of a related function list;
searching, when the request for the related function is the request for invocation, a stored table containing mappings between shortcut keys and the related function for the key input, and invoking the related function corresponding to the key input; and
displaying, when the request for the related function is the request for display, the related function list, and invoking the related function selected by a user from the related function list.

7. The method of claim 6, wherein the request for invocation of the related function is made through an input of multiple keys.

8. The method of claim 7, wherein the input of the multiple keys comprises an input of two keys.

9. The method of claim 8, wherein the two keys comprise a ‘menu’ key and an alphabet key.

10. The method of claim 9, wherein a long key press on the ‘menu’ key followed by the alphabet key is recognized as a request for invocation of the related function.

11. The method of claim 6, wherein the request for display of a related function list is made through a single input of a ‘menu’ key.

12. The method of claim 11, wherein the related function list is a list of functions that are related to the application in execution and are configured according to user preferences.

13. A mobile terminal comprising:
a display unit for displaying, in a function configuration mode, a list of all functions related to a selected application, and for displaying, in response to a request for related function display during application execution, a related function list of the selected application;
a memory unit for storing a general purpose table containing mappings between shortcut keys and commonly used functions, and for storing a user specific table containing mappings between shortcut keys and related functions set by a user; and
a control unit for configuring the related function list for the selected application, for executing the selected application, and, in response to a key input during application execution, for directly invoking a related function or controlling the display unit to display the related function list, and then for invoking a related function selected from the related function list.

14. The mobile terminal of claim 13, wherein the control unit comprises:
a function configurator for determining, in a function configuration mode, whether a function to be configured is present in a displayed list of functions, for selecting, when a function to be configured is present, the function, for displaying, when the function to be configured is not present, the general purpose table and for selecting one of the functions from the general purpose table, for assigning a shortcut key to the selected function if necessary, and for adding the selected function to the related function list if the selected function is not present in the displayed list; and
a function invoker for determining, during execution of the selected application, whether a request for a related function is made using a key input, for determining, when the request for the related function is made, whether the request for the related function is a request for invocation or a request for a related function display, for searching, when the request for the related function is the request for invocation, the user specific table for the key input and for invoking the related function corresponding to the key input, and for displaying, when the request for the related function is the request for the related function display, the related function list and for invoking the related function selected from the related function list according to a user input.

15. The mobile terminal of claim 14, further comprising an input unit having a plurality of keys including a ‘menu’ key and alphabet keys for shortcut keys.

16. The mobile terminal of claim 15, wherein a shortcut key comprises a combination of two keys.

17. The mobile terminal of claim 16, wherein the function invoker regards a long key press on the ‘menu’ key followed by an alphabet key as a request for invocation of the related function.

18. The mobile terminal of claim 17, wherein the function invoker regards a single input of the ‘menu’ key as a request for the related function display.

19. The mobile terminal of claim 18, wherein the related function list is a list of functions that are related to the application in execution and are configured according to user preferences.
